(19) United States
(12) Patent Application Publication
(10) Pub. No.: US 2012/0000492 A1
(43) Pub. Date: Jan. 5, 2012

(54) SYSTEM FOR TREATING AND/OR PROCESSING LIQUID PRODUCTS AND METHOD FOR CLEANING COMPONENTS OF SUCH SYSTEMS

(75) Inventors: Hans-Jürgen Katzenbächer, Bad Kreuznach (DE); Anne Bidinger, Bad Kreuznach (DE); Michael Breil, Andernach (DE)

(73) Assignee: KHS GMBH, Dortmund (DE)

(21) Appl. No.: 13/255,361

(22) PCT Filed: Jul. 14, 2010
(86) PCT No.: PCT/EP10/04268

§ 371 Date: Sep. 8, 2011

(30) Foreign Application Priority Data
Jul. 24, 2009 (DE) 10 2009 034 693.7

(51) Int. Cl. B08B 3/04; B08B 9/08; B08B 9/02

(52) U.S. Cl. 134/26; 134/99.1; 134/99.2; 134/56 R

(57) ABSTRACT

System for treating and/or processing liquid products, in particular beverages, having at least two system components, having a cleaning and rinsing system for cleaning and rinsing of at least product-carrying regions of the system components with at least one liquid cleaning and rinsing medium, and having at least one source for providing the cleaning and rinsing medium.

The invention relates to a system according to the preamble of claim 1 and specifically to a system comprising a cleaning and rinsing system for rinsing and cleaning system components and connections between system components, i.e. in particular for cleaning and rinsing product-carrying chambers and channels of the system components and product-carrying lines between these components, including in a CIP cleaning and rinsing mode. The invention also relates to a method according to the preamble of claim 18.

Cleaning and rinsing systems in particular also for cleaning systems for providing, preparing and bottling liquid products, preferably beverages, into bottles or into other containers are known.

The known systems are in principle configured in such a way that, during the respective cleaning and rinsing mode, all the system components with their regions to be cleaned as well as all the product-carrying connections and lines between the system components are arranged in series and thus form a single CIP circuit through which the respective cleaning and rinsing medium flows. This design means that every volume element of the cleaning or rinsing media is invariably passed through all the system components and all the connections and lines.

If a plurality of different cleaning and rinsing media are used during the cleaning and rinsing mode, namely for example hot water, acid, alkaline solution and fresh water, as is generally customary, the system components arranged in series in the CIP circuit are treated in temporal succession with these cleaning and rinsing media.

In known systems or in the cleaning and rinsing systems thereof, it is disadvantageous inter alia that a relatively long time is required for the cleaning and rinsing mode. This can be attributed inter alia to the fact that the total time required for the cleaning and rinsing mode depends on the longest treatment duration required for one individual system component, and that in addition all the system components are in each case treated with all the cleaning and rinsing media used in the cleaning and rinsing mode, even though it would be more advantageous, namely in particular both with regard to the quality of the cleaning and rinsing result and with regard to a total duration of the cleaning and rinsing process that is as short as possible, to treat the system components with selected cleaning and rinsing media which are different in each case.

In practice, therefore, the treatment duration is generally determined by the treatment duration of the container filling machine since this must be cleaned in a particularly intensive manner due to its numerous small and angled liquid channels and the similar valve arrangements, which is usually achieved by a long treatment time.

In known systems, it is also highly disadvantageous that all the system components arranged in series must be fully prepared for the subsequent cleaning process before the latter can start. The preparation of the container filling machine is particularly laborious, inter alia due to the fact that each filling point must be provided with a so-called rinsing cap or rinsing sleeve.

In the context of the invention, “system components” are in principle all the components or devices of a system for which cleaning and/or rinsing is required, in particular those components or devices which are used to provide, prepare and/or process the respective product during normal operation of the system. In this context, system components are inter alia components for mixing different product components, for carbonating or adding CO2 to products, for briefly heating or pasteurising products (including flash pasteurising units), buffer stores for the intermediate storage of products, filling machines, etc.

The problem addressed by the invention is that of providing a system which has a considerably improved cleaning and rinsing system for the system components. In order to solve this problem, a system is configured according to claim 1. A method for cleaning system components of such a system forms the subject matter of claim 18.

One particular feature of the invention lies in the fact that the cleaning and rinsing system for at least one cleaning and rinsing medium has a closed system circuit which is formed by at least one ring line and in which the source providing the cleaning and rinsing medium is also arranged.

The system components can be connected to this system circuit by a cleaning or rinsing path feed pipe of their respective cleaning and rinsing path and by a cleaning or rinsing path return pipe of their respective cleaning and rinsing path, via valve devices, namely without interrupting the system circuit, i.e. in such a way that the cleaning and rinsing path through the system component in question lies parallel to that part of the system circuit which extends between the cleaning or rinsing path feed pipe and the cleaning or rinsing path return pipe and through which the cleaning and rinsing medium flows. In order to clean and rinse the system components, therefore, the cleaning and rinsing medium is in each case tapped off in sufficient quantity from the system circuit and is fed back to the latter. The ring lines forming the system circuits are led to all the system components for which cleaning and rinsing is required.

As a result it is possible, in particular even when there are a plurality of system circuits or ring lines provided separately for different cleaning media in each case, to treat different system components at the same time and/or in a temporally overlapping manner and/or in a temporally offset manner with identical or different cleaning and rinsing media during the cleaning and rinsing mode, and/or to select the treatment duration of each system component in a manner that is optimal for this component and different from the treatment duration of other system components.

It is also now possible to treat the system components in an optimised sequence and using optimised methods, so that the downtime of the system as a whole is considerably reduced. For example, it is particularly advantageous if the operating staff firstly prepares the system component with the longest treatment duration—for example the filling machine—and starts with the cleaning of this system component. By virtue of this procedure, the work required in order to prepare the further system components is carried out in parallel with the already ongoing process of cleaning the system component that takes the longest time to clean, which ultimately leads to a reduction in downtime.

In order to ensure that the cleaning and rinsing medium supplied to the respective system component is also fed back to the system circuit carrying this cleaning and rinsing medium or to the corresponding ring line, that is to say no or substantially no mixing of different cleaning and rinsing media takes place, each system component is configured with its own media separation.

A wide range of different cleaning and rinsing methods are possible using the cleaning and rinsing system, in particular including product-specific cleaning and rinsing methods, i.e. methods specially adapted to the respective product processed in the system. Besides conventional cleaning and rinsing methods, it is also possible to carry out those in which use is made of heated alkaline solution and/or alkaline solution and/or acid to which a disinfectant has been added and which has been warmed for example, wherein, for different products, in particular also for different beverages, there is no need for hot water sterilisation, namely when use is made of hot alkaline solution or warm alkaline solution containing disinfectant. In this case, it may be necessary to finish the cleaning and rinsing process in each case using a prepared water, i.e. for example water containing added disinfectant, in order to achieve the necessary hygiene status of the system after cleaning and rinsing.

Further developments, advantages and possible uses of the invention will also become apparent from the following description of examples of embodiments and from the figures. All the features described and/or shown form in principle, per se or in any combination, the subject matter of the invention, regardless of the way in which they are combined in the claims or the way in which they refer back to one another. The content of the claims is also included as part of the description.

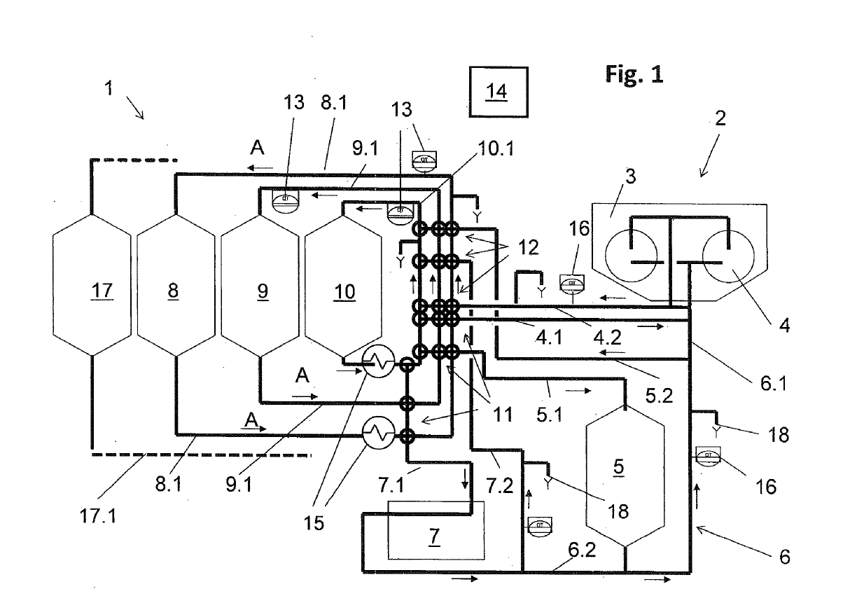

The invention will be explained in more detail below with reference to FIGS. 1 to 3, which in each case show in a schematic functional diagram the cleaning system of different systems for filling containers with a liquid filling substance or product.

The system denoted generally by 1 in FIG. 1 comprises as system components inter alia a filling machine 2 for filling the liquid filling substance into containers (not shown). In the manner known to the person skilled in the art, the filling machine 2, which is shown only schematically, is configured with a rotor 3 and with a product vessel or ring-shaped vessel 4 which is provided on the rotor 3 and which is at least partially filled with the liquid filling substance or product during the filling mode.

The system 1 furthermore comprises a buffer tank 5 which is connected to the filling machine 2 via a product line 6 and serves during the filling mode to hold a buffer quantity of the product in order thus to ensure a continuous inflow of product to the filling machine 2 or to the filling substance vessel 4 thereof and thus a continuous filling mode.

The system 1 shown in FIG. 1 contains as a further system component a flash pasteurising device or unit 7 which is often also referred to as a pasteuriser and in which for example the product is also briefly heated and then cooled in an internal circuit for sterilisation purposes, i.e. is pasteurised. The flash pasteurising unit 7 is connected via the product line 6 to the buffer tank 5 and to the filling machine 2. The product is fed to the flash pasteurising unit 7 via a product line (not shown) from a device for providing the filling substance, for example from a reservoir or a mixing unit.

The system 1 comprises, in addition to the system components mentioned above and possible further system components, also a cleaning and rinsing system for cleaning and rinsing the system components, in particular all the product-carrying chambers, channels and lines. In the illustrated embodiment, the cleaning and rinsing system is configured with at least three tanks or containers 8, 9 and 10 for in each case a specific liquid cleaning or rinsing medium, namely with the container 8 for alkaline solution, the container 9 for acid and the container 10 for hot water. Each container 8-10 is part of a separate system circuit which is essentially formed in each case by a ring line 8.1, 9.1 or 10.1 which is fed back from a lower outlet of the relevant container 8, 9, 10 to an upper inlet of this container. In detail, the system circuits are formed by the ring line 8.1 assigned to the container 8, by the ring line 9.1 assigned to the container 9 and by the ring line 10.1 assigned to the container 10. For circulating the cleaning and rinsing medium in the flow direction indicated by the arrows A, at least one circulating pump (not shown in the figures) is provided in each ring line 8.1, 9.1 and 10.1.

Also provided in the ring lines 8.1-10.1 are controllable valve arrangements 11 and, downstream of the latter in the flow direction A, controllable valve units 12, via which the rinsing of the system components (filler 2, buffer tank 5 and flash pasteurising unit 7) with the different cleaning and rinsing media from the containers 8-10 can be controlled individually in the manner described in more detail below, in particular also in such a way that different system components are treated at the same time or in a temporally overlapping manner with different cleaning and rinsing media. For each system component, a respective control unit 11 and a respective control unit 12 are provided.

Provided in the ring lines 8.1-10.1 downstream of the valve units 11 and 12 and thus upstream of the inlet into the respective containers 8-10 in the flow direction A are sensors 13 which supply measurement signals to a central control unit 14, by means of which the type of cleaning and rinsing medium fed back to a container 8-10 is monitored. By means of the control unit 14, the valve units 11 and 12 are controlled in such a way that there is fed back into each container 8-10 only the cleaning and rinsing medium actually assigned to said container, i.e. only alkaline solution into the container 8, only acid into the container 9 and only hot water into the container 10. Also provided in the ring lines 8.1 and 10.1, upstream of the first valve unit 11 in the flow direction A, is a respective heating device 15 for heating the alkaline solution and also the hot water.

For rinsing in the closed circuit, the system components, namely the filling machine 2 or the product vessel 4 thereof, the buffer store 5 and the flash pasteurising unit 7, are each connected by a rinsing line feed pipe to the valve units 11 and by a rinsing line return pipe to the valve units 12, namely
the product vessel 4 by a rinsing line feed pipe 4.1 to the associated valve unit 11 and by a rinsing line return pipe 4.2 to the associated valve device,
the buffer store 5 by a rinsing line feed pipe 5.1 to the associated valve unit 11 and by a rinsing line return pipe 5.2 to the associated valve unit 12, and
the flash pasteurising unit by a rinsing line feed pipe 7.1 to the associated valve unit 11 and by a rinsing line return pipe 7.2 to the associated valve unit 12.

Each valve unit 11 and 12 has at least four switching states, namely one switching state in which the connection to the connected rinsing line feed pipe or return pipe is blocked and three switching states in which the respective rinsing line feed pipe assigned to a system component and the rinsing line return pipe assigned to said system component is connected to one of the ring lines 8.1-10.1 in order to tap off the cleaning and rinsing medium that is used and in order to feed back the cleaning and rinsing medium to the container 8-10 assigned to this treatment medium.

The rinsing line feed pipes 4.1, 5.1 and 7.1 and the associated rinsing line return pipes 4.2, 5.2 and 7.2 in each case form the connections of a component-side cleaning and rinsing path which includes all the chambers, channels, connections, lines, etc. to be cleaned on the system component in question. Each of these cleaning and rinsing paths is assigned means for media separation, i.e. means which ensure that the cleaning and rinsing medium fed back from a cleaning and rinsing path is actually fed back, by appropriate actuation in particular of the valve units 12, to the ring line 8.1-10.1 assigned to the respective cleaning and rinsing medium and thus to the correct container 8-10. To this end, in the illustrated embodiment, sensors 15 which are connected to the control device 14 are provided in the rinsing line return pipes 4.2, 5.2 and 7.2, which sensors detect the type of cleaning and rinsing medium flowing back from the system component and the signals of which trigger an appropriate actuation of the valve units 12.

In the simplest case, the valve units 11 and 12 consist of in each case three individually controllable valves which are configured as diverter valves and each of which is connected to a ring line 8.1-10.1 and via which the rinsing line feed pipes and return pipes can be connected in a controlled manner to the respective ring line. The outputs of the three control valves forming the respective valve unit 11 or 12 are connected in parallel and are connected to a respective rinsing line feed pipe or rinsing line return pipe.

As shown in FIG. 1, the rinsing line feed pipes and return pipes also include significant portions of the product line 6, so that these portions can automatically also be cleaned and rinsed during the cleaning and rinsing of the system components. In the illustrated embodiment, this applies with the exception of the portions denoted 6.1 and 6.2 in FIG. 1, which can nevertheless likewise be cleaned and rinsed with the respective cleaning and rinsing medium by appropriate actuation of the valve units 11 and 12.

In addition to the possibility of cleaning and rinsing the system components with alkaline solution, acid and hot water, the system 1 also has the possibility of e.g. a final rinsing with fresh water. To this end, a source of fresh water in the form of a further tank or container 17 is shown in FIG. 1. The valve units 11 and 12 are in this case expanded by an additional switching function or an additional valve, which makes it possible to rinse the system components also with fresh water via the individual component-side cleaning and rinsing paths and to divert said fresh water into a channel system or a fresh water preparation system.

For emptying purposes, the rinsing lines and in particular the rinsing line return pipes 4.2, 5.2 and 7.3 are each provided with an outlet valve or drain valve 18.

A wide range of cleaning or rinsing methods are possible depending on the filling substance or product, namely in each case preferably in accordance with cleaning programmes which are stored in a product-related manner in a memory of the control device 14. Possible cleaning concepts or methods are for example:

Conventional Cleaning
1. Pre-rinsing with water
2. Treatment with hot alkaline solution (approx. 85° C.)
3. Intermediate rinsing with warm or hot water
4. Treatment with acid
5. Rinsing with hot water
6. Subsequent rinsing with fresh water

Hot Cleaning
1. Rinsing with hot alkaline solution (approx. 85° C.)
2. Subsequent rinsing with cold water
3. Treatment with acid optionally containing added disinfectant
4. Subsequent rinsing with fresh water optionally containing added disinfectant, e.g. ClO2

The above method steps 2. and 3. may also be carried out repeatedly multiple times.

Cold Cleaning
1. Treatment with alkaline solution, for example with heated alkaline solution (approx. 40° C.) containing added disinfectant and an activator
2. Intermediate rinsing with cold water
3. Treatment with acid and disinfectant
4. Subsequent rinsing with fresh water optionally containing added disinfectant (e.g. ClO2)

The above method steps 2. and 3. may also be carried out repeatedly multiple times.

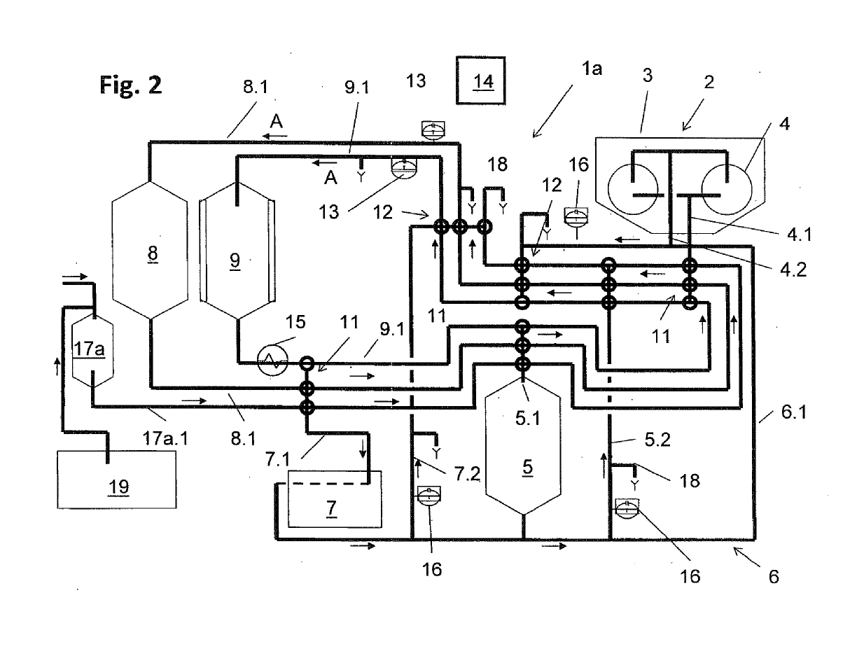

FIG. 2 shows as a further embodiment a system 1a which once again comprises the system components in the form of the filling machine 2, the buffer tank 5 and the flash pasteurising unit 7, but which differs from the system 1 with regard to the design of the cleaning and rinsing system. Specifically, in the system 1a, the container 10 for the rinsing water or hot water and the ring line 10.1 assigned to this container are omitted. Instead of the container 17, a buffer tank or container 17a is provided which is connected to a source for supplying the fresh water and which is assigned an activator 19 for mixing a disinfectant (e.g. 0102) into the fresh water.

The valve units 11 and 12 are respectively connected to the ring lines 8.1 and 9.1 and also to a line 17a.1 of the container 17a, namely once again in such a way that the valve units 11 are located upstream of the valve units 12 in relation to the flow direction A of the cleaning and rinsing media in the ring lines 8.1 and 9.1 and also in relation to the flow direction A of the water provided by the container 17a.

In particular also with regard to the design of the system components, namely the filling machine 2, the buffer tank 5 and the flash pasteurising unit 7 and also the cleaning and rinsing paths internal to the components which include the chambers, channels, lines, etc. thereof and which extend between the rinsing line feed pipes 4.1, 5.1 and 7.1 and the rinsing line return pipes 4.2, 5.2 and 7.2, the system 1a corresponds to the system 1. This also applies in relation to the aforementioned cleaning and rinsing methods, wherein the intermediate rinsing and subsequent rinsing in the examples of possible cleaning methods described above take place e.g. in each case using water from the container 17a.

The system 1a is particularly suitable for the bottling of beer and beer-based mixed beverages.

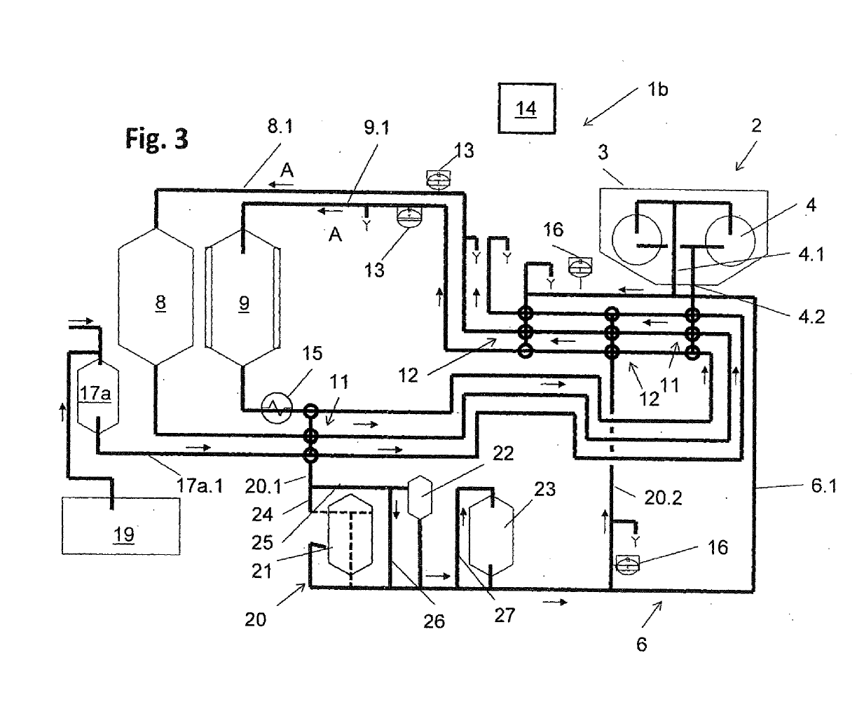

FIG. 3 shows as a further embodiment a system 1b which differs from the system 1a in that, instead of the flash pasteurising unit 7, a mixer generally denoted by 20 is provided in FIG. 3 and also the buffer tank 7 is omitted. The mixer 20, which supplies the product to be bottled in the filling machine 2 as a mixed product consisting of a main component, for example in the form of carbonated water, and of an additional component, for example in the form of a flavouring additive, comprises inter alia, in the manner known to the person skilled in the art, a tank 21 for providing the main component, a tank 22 for providing the additional component, a buffer tank 23, etc.

The tanks 21 and 22 and the buffer tank 23 are in each case connected to a lower outlet and, via control valves (not shown), to the product line 6 in which there is also provided a mixing device (not shown) or mixing section for mixing the main component and the additional component and also optionally for incorporating CO2 into one of the components or into the mixed product.

Reference 20.1 denotes the rinsing line feed pipe which is connected to one of the valve units 11 and is provided for cleaning and rinsing the mixer 20. An upper inlet of the tank 21 and an upper inlet of the tank 22 are respectively connected to this rinsing line feed pipe 20.1, namely via the lines 24 and 25. Additional lines 26 and 27 are provided between the upper connection of the tank 22 and the product line 6 and between the upper connection of the buffer tank 23 and the product line 6. The product line 6 is in turn part of the rinsing line return pipe of the mixer 20, said return pipe being denoted 20.2 in FIG. 1b and being connected to the valve unit 12.

Furthermore, the system 1b comprises only two valve units 11 and two valve units 12. Via the valve units 11, which are arranged upstream of the valve units 12 in the flow direction A of the cleaning and treatment media in the ring lines 8.1 and 9.1 and of the water in the line 17a.1, the rinsing line feed pipes 4.1 and 20.1 can be selectively connected to the ring lines 8.1 and 9.1 and to the line 17a.1 Via the valve units 12, the rinsing line return pipes 4.2 and 20.2 can respectively be connected, in a controlled manner and as a function of the cleaning and rinsing medium presently being used, to the associated ring line 8.1 or 9.1 and to the line 17a.1

Regardless of the cleaning and rinsing medium presently being used, in order to treat the mixer 20 said medium is supplied to the rinsing line feed pipe 20.1 via the associated valve unit 11 and in the process flows through the tanks 21 and 22 and also all the lines and connections of the mixer 20, in particular including the lines 24, 25 and 26, and also, via the line 27, the buffer tank 23 before the cleaning and rinsing medium is then conveyed away via the rinsing line return pipe 20.2. It may be advantageous here to control the flow of the cleaning and rinsing medium by appropriate actuation of control valves provided in the mixer 20, in order to achieve an optimal treatment of all the components, in particular including all the product-carrying components of the mixer 20.

The sensor 16 for media separation and the valve 18 for venting or emptying are provided in the rinsing line return pipe 20.2.

The system 1b is particularly suitable for the bottling of CSD beverages, i.e. carbonated soft drinks.

If the product accommodated in the buffer store 7 or 23 is a carbonated product, which is kept under pressure in the buffer store during the filling mode by means of a CO2 gas buffer, the cleaning and rinsing of the buffer store 7 or 23 takes place without the use of alkaline solution. Rather, during the cleaning and rinsing, use is made of acid instead of alkaline solution so as to avoid, without any gas exchange, a hazardous overpressure which is generated by a chemical reaction and which destroys the buffer store 7 or 23 and thus the system 1, 1a and 1b. The same also applies to the cleaning and rinsing of other system components of the respective system which remain filled with CO2 gas during the cleaning and rinsing. By virtue of the configuration according to the invention, however, it is possible to treat other system components, which do not contain CO2 gas, in a simultaneous or temporally overlapping manner with alkaline solution.

The invention has been described above on the basis of examples of embodiments. It will be understood that numerous changes and modifications are possible without thereby departing from the inventive concept on which the invention is based.

### LIST OF REFERENCES

1, 1a, 1b system

2 filling machine

3 rotor

4 filling substance vessel or ring-shaped vessel

4.1 rinsing line feed pipe

4.2 rinsing line return pipe

5 buffer tank

5.1 rinsing line feed pipe

5.2 rinsing line return pipe

6 product line

6.1, 6.2 portion of the product line

7 flash pasteurising unit

7.1 rinsing line feed pipe

7.2 rinsing line return pipe

8, 9, 10 container or tank

8.1, 9.1, 10.1 ring line

11.1-11.3 valve unit

12.1-12.3 valve unit

13 sensor

14 2electronic control device or control computer

15 heating device

16 sensor

17, 17a container for fresh water

17a.1 line for fresh water

18, 19 outlet valve

20 mixer unit

20.1 rinsing line feed pipe

20.2 rinsing line return pipe

21, 22 container or tank

23 buffer tank

A flow direction of the cleaning and rinsing medium

1-22. (canceled)

23. An apparatus for treating and/or processing liquid products, said apparatus comprising:
at least two system components;
a cleaning and rinsing system for cleaning and rinsing product-carrying regions of said system components with at least one liquid cleaning and rinsing medium, said cleaning and rinsing system including a system circuit having:
a source for providing said at least one cleaning and rinsing medium, and
a ring line connected to said source through which said cleaning and rinsing medium can be circulated in a conveying and flow direction,
wherein each of said system components is assigned
a first valve unit for enabling controlled tapping of said cleaning and rinsing medium for cleaning and rinsing said system component from said system circuit or from said ring line thereof, and
a second valve unit for enabling controlled feeding back of said cleaning and rinsing medium to said system circuit carrying said cleaning and rinsing medium or to said ring line thereof after cleaning and rinsing said system component,
said second valve unit being provided downstream, in the conveying and flow direction, of said first valve unit assigned to said system component, and
wherein said first and second valve units are configured such that said tapping and said feeding back take place without interrupting said system circuit in a course between said first and second valve units.

24. The apparatus of claim 23, wherein said cleaning and rinsing system comprises at least two sources for providing corresponding different cleaning and rinsing media,
each of said sources being a part of an independent system circuit having at least one ring line and being associated with corresponding first and second valve units,
said first and second valve units being configured such that said cleaning and rinsing medium carried in each of said corresponding system circuits can be tapped in a controlled manner from said system circuit and fed back to said corresponding system circuit.

25. The apparatus of claim 23, wherein said system components comprise cleaning and rinsing paths through which the cleaning and rinsing medium can flow during said cleaning and rinsing,
wherein each of said cleaning and rinsing paths comprises:
at least one cleaning or rinsing path feed pipe for tapping off said cleaning and rinsing medium, said feed pipe being connected to a corresponding first valve unit, and
at least one cleaning or rinsing path return pipe for feeding back said cleaning and rinsing medium, said return pipe being connected to a corresponding second valve unit.

26. The apparatus of claim 24, wherein, for each of said independent system circuits, said associated first valve unit is arranged upstream of said associated second valve unit in relation to a conveying and flow direction of said cleaning and rinsing medium in said system circuit.

27. The apparatus of claim 23, wherein said source for providing said cleaning and rinsing medium is a source of a medium selected from the group consisting of acid solution, alkaline solution, water, and heated water.

28. The apparatus of claim 23, further comprising
a further source for water containing added disinfectant,
wherein cleaning or rinsing path feed pipes and cleaning or rinsing path return pipes are connected via the first and second valve units to a line connected to said further source for enabling controlled tapping off and feeding back of said water containing added disinfectant.

29. The apparatus of claim 23, wherein said source for providing the cleaning and rinsing medium comprises at least one of a container and a tank accommodating said cleaning and rinsing medium.

30. The apparatus of claim 28, wherein said further source comprises at least one of a container and a tank accommodating said water containing added disinfectant.

31. The apparatus of claim 28, wherein said line connected to said further source leads to at least one of an outlet and a drain.

32. The apparatus of claim 23, further comprising
a control device for controlling said first and second valve units to cause cleaning and rinsing medium fed to a system component from said system circuit or said ring line to be fed back to said system circuit or said ring line via said second valve unit.

33. The apparatus of claim 23, further comprising
a sensor for monitoring a type of cleaning and rinsing medium and/or a quality thereof.

34. The apparatus of claim 23, further comprising:
a heating element for heating cleaning and rinsing medium in at least one system circuit or in an associated ring line.

35. The apparatus of claim 23, further comprising means for ensuring separation of said cleaning and rinsing medium in component-side cleaning and rinsing paths.

36. The apparatus of claim 35, wherein said means for separating said cleaning and rinsing medium comprises:
sensors arranged in said system components or in cleaning and rinsing paths associated therewith, said sensors detecting a type of cleaning and rinsing medium being fed back for causing actuation, via a control device, of said second valve units to cause cleaning and rinsing medium from said system component to be fed back into one of a line and a ring line carrying said cleaning and rinsing medium.

37. The apparatus of claim 36, wherein said sensors are arranged in the cleaning or rinsing path return pipes.

38. The apparatus of claim 24, further comprising a control device for individually controlling said first and second valve units to enable system components to be treated with cleaning and rinsing media of different types simultaneously and/or in a temporally overlapping manner.

39. The apparatus of claim 23, wherein said source for providing the cleaning and rinsing medium comprises means for preparing said cleaning and rinsing medium.

40. The apparatus of claim 23, wherein one of said system components is a filler or filling machine for bottling beverages into containers.

41. The apparatus of claim 23, wherein one of said system components is selected from the group consisting of a buffer store, a flash pasteurizing unit, and a mixer unit.

42. A method for cleaning and rinsing system components of an apparatus for treating and/or processing liquid products, said method comprising
cleaning and rinsing system components independently of cleaning and rinsing of further system components using a plurality of cleaning and rinsing media.

43. The method of claim 42, wherein cleaning and rinsing system components comprises cleaning and rinsing said system components simultaneously or in a temporally overlapping manner, wherein each system component is cleaned and rinsed using a different cleaning and rinsing medium.

44. The method of claim 42, further comprising
circulating said cleaning and rinsing media in separate system circuits, and,
cleaning and rinsing a system component with a particular medium by tapping off said particular medium from a system circuit carrying said particular medium.

45. The method of claim 44, further comprising, after said system component has been cleaned and rinsed by said particular medium, feeding back said particular medium to the system circuit carrying said particular medium.

46. The method of claim 42, further comprising
beginning cleaning and rinsing of a system component that takes longer to clean and rinse than other system components before beginning cleaning and rinsing of said other system components.
